(19) United States
(12) Patent Application Publication
(10) Pub. No.: US 2025/0068462 A1
(43) Pub. Date: Feb. 27, 2025

(54) Heterogeneous Processor With High-Speed Decision Tree Scheduler

(71) Applicant: Wisconsin Alumni Research Foundation, Madison, WI (US)

(72) Inventors: Umit Ogras, Middleton, WI (US); Toygun Basaklar, Madison, WI (US); Ahmet Goksoy, Madison, WI (US); Anish Krishnakumar, Madison, WI (US)

(21) Appl. No.: 18/236,638

(22) Filed: Aug. 22, 2023

(51) Int. Cl. G06F 9/38

(52) U.S. Cl. CPC G06F 9/4881; G06F 2209/501; G06F 2209/503; G06F 2209/505

(57) ABSTRACT

A scheduling system for heterogeneous processors having similar cores grouped by clusters employs a differentiable decision tree having nodes operating on multiple feature values indicating a current runtime state of the processor. By implementing the scheduling with a trained decision tree, extremely fast scheduling decisions can be made.

### STATEMENT REGARDING FEDERALLY SPONSORED RESEARCH OR DEVELOPMENT

This invention was made with government support under FA8650-18-2-7860 awarded by the USAF/AFMC and under CNS2114499 awarded by the National Science Foundation. The government has certain rights in the invention.

### CROSS REFERENCE TO RELATED APPLICATION

### BACKGROUND OF THE INVENTION

The present invention relates generally to heterogeneous computer architectures and more particularly to a system and methods for scheduling application tasks in such systems.

The growing demand for high-performance and energy-efficient processing in machine learning, image processing, and wireless communication has led to the rise of computer architectures combining general purpose processors with specialized hardware accelerators such as digital signal processors (DSPs), image signal processors (ISPs), and fixed function accelerators performing fast Fourier transform encoding and Viterbi decoding operations.

Scheduling application tasks on such heterogeneous architectures is difficult. Simple heuristics can be used but they are typically limited to specific use cases that, by their nature, fall short of an optimal solution. More sophisticated approaches, such as machine learning, incur high runtime overheads.

Desirably a scheduling system could be developed to make near-optimal scheduling decisions within nanoseconds to be on par with the task execution times in such heterogeneous architectures.

### SUMMARY OF THE INVENTION

The present invention provides a scheduling system employing a decision tree scheduler capable of sophisticated nanosecond scheduling decisions with relatively few calculations. The decision tree is designed to be differentiable allowing it to be pre-trained using a simulation of the heterogeneous architecture. The training system may integrate multiple objectives allowing runtime adjustment of the objectives with a single trained model.

More specifically, in one embodiment, the invention provides a computer architecture having a plurality of heterogeneous processor cores having clusters of homogeneous processor cores. A computer memory stores the operating program instructions that, when executed on the computer, cause the computer to: (1) collect a set of feature values related to the performance of the heterogeneous processor cores during up execution of an application program instructions comprised of tasks; (2) identify a task of the application program instructions to be executed on a plurality of heterogeneous processor cores; (3) apply the feature values to a decision tree providing a set of nodes selecting among branches to other nodes according to a node function the feature values to identify a leaf node associated with a cluster; and (4) assign the task to the cluster identified by the identified leaf node.

It is thus a feature of at least one embodiment of the invention to provide a computationally fast and efficient mechanism for task scheduling consistent with the high-speed operation of heterogeneous cores.

The computer may further assign the task to a processor core of the identified cluster according to an availability of the processor cores.

It is thus a feature of at least one embodiment of the invention to enlist a simple heuristic for selecting cores in a cluster where sophisticated analysis of the operating state of the computer is not required.

The feature values may include any of a position of a task in a directed graph of the application, the application type, and the availability of processor cores within the clusters.

It is thus a feature of at least one embodiment of the invention to identify important features that can affect scheduling efficiency and be readily determined during runtime.

The operating program when executed on the computer may receive an objective value indicating the desired trade-off between different scheduling objectives and wherein performance value is applied as a feature value to the decision tree.

It is thus a feature of at least one embodiment of the invention to allow design-and run-time changes in scheduling objectives, for example, to emphasize power consumption or to emphasize execution speed.

The decision tree maybe differentiable.

It is thus a feature of at least one embodiment of the invention to provide a decision tree whose weights can be trained by reinforcement learning.

The node functions in the decision tree maybe differentiable functions of multiple feature values.

It is thus a feature of at least one embodiment of the invention to provide for effective use of a shallow decision tree for each node that can look at a full set of feature values.

At least some node functions may be a vector multiplication of a weight factor times a vector of feature values.

It is thus a feature of at least one embodiment of the invention to provide a scheduling system that greatly reduces the calculation burden compared to, for example, a neural network type structure.

The node functions include multiple weight values trained using a simulation of the computer.

It is thus a feature of at least one embodiment of the invention to provide a simple method of determining node weights.

The training may employ multiple different application programs and multiple objective values selected from the group consisting of: computer energy usage and application program execution time.

It is thus a feature of at least one embodiment of the invention to allow the scheduling system to accommodate multiple objective functions with a single set of trained weights, eliminating disruption when scheduling objectives change.

These particular objects and advantages may apply to only some embodiments falling within the claims and thus do not define the scope of the invention.

### BRIEF DESCRIPTION OF THE DRAWINGS

FIG. 1 is a representation of a heterogeneous computer architecture suitable for incorporation of the scheduling system of the present invention and providing multiple cluster processing elements for executing application programs and showing a representation of an application program and its tasks as a directed flow graph (DFG);

FIG. 2 is a flowchart showing operation of the scheduling system on the architecture of FIG. 1 using a differentiable decision tree;

FIG. 3 is a logical representation a differentiable decision tree suitable for use in the present invention having leaf nodes identifying particular clusters for task scheduling; and

FIG. 4 is a block diagram of a training system for training the differentiable decision tree of FIG. 3 prior to use.

### DETAILED DESCRIPTION OF THE PREFERRED EMBODIMENT

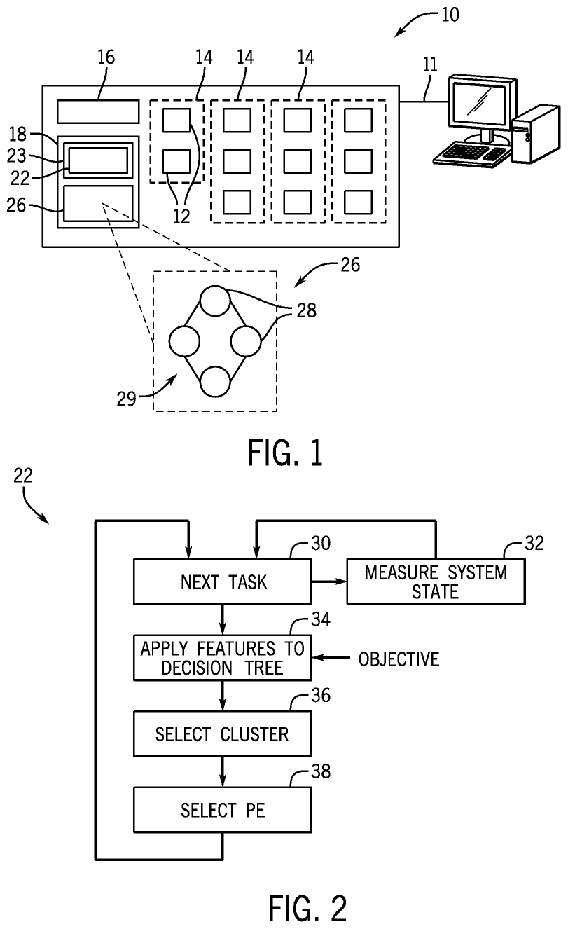

Referring now to FIG. 1, a heterogeneous computer 10 suitable for use by the present invention may include a number of processing elements 12 grouped functionally by clusters 14. Example processing elements include, but are not limited to, the above-described digital signal processors (DSPs), image signal processors (ISPs), fixed function accelerators for matrix multiplication, fast Fourier transform encoding, and Viterbi decoding operations. The heterogeneous computer may provide an interface 11 to a user terminal, other computers, the Internet or the like.

The heterogeneous computer 10 will also include one or more general purpose processing units (CPU) 16 and a memory structure 18, for example, comprising multiple levels of cache, main memory (DRAM), and disk memories as is generally understood in the art.

The memory structure 18 may hold one or more application programs 26 to be executed by the heterogeneous computer 10 and a scheduling runtime program 22 as will be described below being part of a standard operating system 23.

Generally, each application program 26 may provide a set of tasks 28 executing in a sequence that may be represented as a directed flow graph 29 comprised of nodes representing the tasks 28 and edges representing dependencies between tasks 28. The scheduling runtime program 22 operating in conjunction with the operating system 23 will monitor an operating state of the heterogeneous computer 10 and will guide the allocation of the tasks 28 to particular processing elements 12 and clusters 14 to optimize objectives such as execution speed and power consumption as may change from time to time during operation.

Referring now to FIG. 2, the scheduling runtime program 22, and as indicated by process block 30, may receive from the operating system 23, a task 28 of the application program 26 to be assigned to a processing element 12. Concurrently or during idle time as indicated by process block 32 the scheduling runtime program 22 monitors a number of performance features relevant to scheduling objectives as indicated in Table I

TABLE I

| Feature Information | Description |
|---|---|
| Task ID | a unique identifier of the task within an |
| | application of the task being scheduled |
| Depth of task in DFG | a position of the task being scheduled |
| | within the directed flow graph |
| Application type | The type of application (e.g., wireless |
| | communication) of the task being |
| | scheduled |
| Execution time on C | a set of values indicating how quickly |
| clusters | the processing elements in each given |
| | cluster execute |
| Application ID | a unique identifier of the application of |
| | the task being scheduled |
| Earliest availability of | a set of values providing earliest |
| C clusters | availability of any processing element |
| | within each given cluster |
| Objective preference | a value indicating a desired trade-off |
| | between two objectives, for example, |
| | energy consumption and execution |
| | speed. |

Each of these features may be determined during run time and represents a state of the heterogeneous computer 10 with the exception of the objective preference. The objective preference instead will be provided independently by the operating system according to a user preference or other system parameter, for example, assessing battery life, ambient temperature, or the like, and may vary during runtime.

### Decision Tree Run Time Scheduling

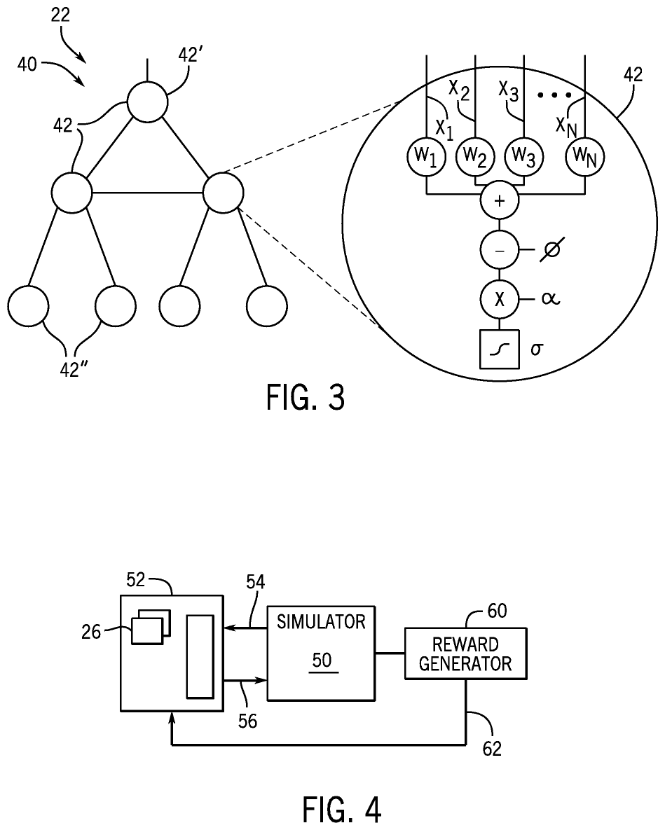

Referring now also to FIG. 3, when a task 28 for scheduling arrives at process block 30, the values of the features of Table I are applied as a vector xi to a decision tree 40 for determining a cluster 14 to which the task 28 will be assigned.

As is generally understood in the art, a decision tree is a hierarchical arrangement of nodes 42 in a tree-like structure extending between a root node 42′ and a set of leaf nodes 42″. At each of the root nodes 42′ and the intermediate nodes 42 above the leaf nodes 42″, a feature value x is compared to a corresponding threshold ϕ to make a binary decision determining along which path to proceed to one of a next pair of nodes 42 (either to the left or to the right node). Traversing the decision tree 40 from a root node 42′ to a leaf node 42″ results in a decision indicated by the single leaf node 42″arrived at after the cumulative branch decisions.

The present invention employs a variation on a standard decision tree to provide a differentiable decision tree 40 where the decisions about proceeding to a next node 42 are based on a continuous function of all feature values. The function at each node 42 result is non-binary (continuous) value representing a decision to go down both branches to the next nodes 42 carrying different weight values determined by the continuous function. So, for example, the continuous function may produce a value between 0 and 1, with the value of zero indicating the path down the left branch carrying a weight of 1 and a value of one indicating a path down the right branch carrying a weight of 1 and the value of 0.6 indicating a path down the left branch carrying a weight of 0.6 and a path down the right branch carrying a weight of 0.4. This structure is described in A. Silva, M. Gombolay, T. Killian, I. Jimenez, and S.-H. Son, Optimization Methods for Interpretable Differentiable Decision Trees Applied to Reinforcement Learning, in International Conference on Artificial Intelligence and Statistics, pages 1855-1865. PMLR, 2020.

The resulting leaf node 42″ selected during this process will be the leaf node 42″ whose path from the leaf node 42′ to itself is associated with the largest accumulated weight. Each given leaf node 42″ is associated with a particular cluster 14 thus a determination of a leaf node 42 also determines the cluster 14 to which a task 28 should be assigned.

In one embodiment, the function at each node will take as arguments a vector of each feature value xᵢ that will be multiplied by a vector of learned weights wᵢ. The resulting sum then has a bias value ϕ subtracted from it (analogous to the threshold value of a normal decision tree), and this result is applied to a sigmoid function after being multiplied by a scaling value α. The sigmoid function operates to provide a continuous and thus differentiable value bounded between 0 and 1 that determines the relative weights assigned to each of the different branches from that node that will ultimately be accumulated at the leaf nodes 42″.

The number of levels of nodes 42 in the decision tree 40 (that is the number of nodes from the root node 42′ to any leaf node 42″) can be constrained to less than the number of features x because each feature is evaluated at each level. In experimental evaluations with five clusters, as few as three levels of nodes may be used to evaluate sixteen features. It will therefore be appreciated that the computational burden of implementing the nodes 42 and the decision tree 40 is relatively small compared to a typical neural network having neurons that are multiply connected. Significantly, a review of the weights w at each node 42 can provide an intuitive understanding of the relative evaluation being performed in contrast to reviewing of the weights of a neural network which provide little intuitive understanding of their operation with respect to the final output.

Referring again to FIG. 2, once the cluster 14 is identified from the leaf node 42″, as indicated by process block 36, a simple heuristic may be employed to identify a particular processing element 12 within the cluster 14, for example, choosing the processing element 12 having the earliest availability.

At process block 38 the task is assigned to the identified processing element and the program repeats.

### Off-Line Decision Tree Training

Referring now to FIGS. 1 and 4, training of the decision tree 40 requires determining the weight values w for each node 42 above the leaf nodes 42″. This may be done by constructing a simulator 50 for the particular heterogeneous computer 10, for example, as described in S. E. Arda et al. DS3: A System-Level Domain-Specific System-on-Chip Simulation Framework. IEEE Trans. on Computers, 69(8): 1248-1262, 2020. A training system 52 using reinforcement learning may then read a current operating state 54 from the simulator 50 (representing the feature values) and provide scheduling instructions 56 controlling how tasks 28 of application programs 26 received by the simulator 50 are allocated to the simulated processing elements 12. These scheduling instructions 56 may originally be quasi-random but after many iterations of training converge on a Pareto optimal solution. In this regard, the simulator 50 receives tasks 28 from a library of different application programs 26 representative of the intended workload of the heterogeneous computer 10. Each of the application programs 26 may be manually identified as to application type or this labeling may be performed automatically by static analysis of the application program 26.

As application programs 26 are run and tasks 28 are scheduled, a reward generator 60 monitors simulated measures of the scheduling objectives (e.g., power consumption, execution time) and develops a multidimensional reward vector 62 which is received by the training system 52 to incrementally adjust the weights to optimize the desired scheduling objectives.

As a preliminary step, a masking is performed to prevent scheduling of a task 28 on a processing clement 12 functionally incapable of executing that task. Optimization of the weights is then performed using any of a variety of optimization techniques to determine the weights w, for example, PPO as discussed in this application.

### MO-PPO Training

In one nonlimiting embodiment, the invention may employ a multi-objective reinforcement learning such as Multi-Objective Reinforcement Learning (MORL) to extend Proximal Policy Optimization (PPO). PPO is described in J. Schulman, F. Wolski, P. Dhariwal, A. Radford, and O. Klimov, Proximal Policy Optimization Algorithms, arXiv preprint arXiv: 1707.06347, 2017and MORL is described generally in X. Chen, A. Ghadirzadeh, M. Bjealunan, and P. Jensfelt, Meta-learning for multi-objective reinforcement learning, in 2019 IEEE/RS.7 International Conference on Intelligent Robots and Systems (IROS), pages 977-983. IEEE, 2019; and in J. Xu, Y. Tian, P. Ma, D. Rus, S. Sueda, and W. Matusik, Prediction-guided multi-objective reinforcement learning for continuous robot control, in International Conference on Machine Learning, pages 10607-10616. PMLR, 2020.

Considering this process in more detail, task scheduling, at its core, is an NP-hard sequential decision-making problem. It can be formulated as a Markov Decision Process (MDP) defined by the tuple [symbol] , [symbol] , [symbol] , r, γ [symbol] , where [symbol] , [symbol] , [symbol] (s′|s, a), r, and γ represent state space, action space, transition distribution, reward vector, and discount factor, respectively. Reinforcement Learning (RL) is a class of algorithms that aims to find an optimal policy for an agent to maximize its cumulative reward in an MDP. According to the state s of the environment and the current policy π, the agent chooses an action a. Based on this action, the environment returns the next state s′ and reward r. The expected cumulative rewards starting from state s following a policy π can be represented as state value function, V^{π}(s). The RL algorithm then iteratively updates the agent's policy (π) and value function (V^{π}) based on the feedback received from the environment in the form of rewards. This process continues until the agent reaches a terminal state or a maximum number of steps.

In a multi-objective setting, each objective is associated with a reward signal, which transforms the scalar reward into a vector r=[r₁, r₂, . . . , r_{M}]^{T}, where M is the number of objectives. This vectorized reward can be represented by a vectorized state value function MV⁹⁰ (s). In the RL domain, scalarization is the most commonly used approach to solve multi-objective optimization problems. This approach transforms the reward vector into a single scalar, f_{ω}(r)=ω^{T}r. The MDP is then transformed into a multi-objective Markov decision process (MOMDP), defined by the tuple [symbol] , [symbol] , [symbol] , r, Ω, f_{ω} [symbol] , where r and Ω represent the reward vector and preference space, respectively. Using a preference ω∈Ω, the function f_{ω}(r)=ω^{T}r yields a scalarized reward. If we fix ω as a vector, the MOMDP can be treated as a standard MDP and solved using conventional RL methods. Nonetheless, if we consider all possible returns and preferences in Ω, we can obtain a set of non-dominated policies referred to as the Pareto front. This set includes non-optimal solutions. A policy π is considered Pareto optimal if no other policy π′ enhances the expected return for an objective without causing degradation in the expected return of any other objective.

In this optimization, we extend the standard proximal policy optimization (PPO) algorithm to a multi-objective (MO-PPO) variant by considering a vectorized reward (r) and state value function (V^{π}). Both the policy and the state value function take preference vector ω as input, efficiently learning the multi-dimensional objective space.

The value network is vectorized to efficiently learn to model multiple objectives for a given preference vector ω. Specifically, the value network takes state s and preference vector ω as inputs and outputs | [symbol] |×M state values, where M is the number of objectives. Therefore, the state value function becomes V_{ϕ}(s, ω), which returns a vector of expected returns for a given state s and preference ω by following a current policy π_{θ}. During training, the vectorized value network is updated by minimizing the mean-squared error between estimated and target values using gradient descent as the optimization algorithm:

$${L}_{ϕ} = \frac{1}{T} {\sum }_{t = 0}^{T} {( {V}_{ϕ} ( {s}_{t} , ω ) - ( {r}_{t} + γ {V}_{ϕ} ( {s}_{t + 1} , ω ) ) )}^{2}$$

The vectorization of the reward and state value function results in a vectorized advantage function, as follows:

$$A ( {s}_{t} , {a}_{t} , ω ) = {r}_{t} + γ {V}_{ϕ} ( {s}_{t + 1} , ω ) - {V}_{ϕ} ( {s}_{t} , ω )$$

To compute the modified advantage function, ω^{T}A(sₜ, aₜ, ω), a weighted-sum scalarization is applied to the advantage function, similar to the state value function. Furthermore, in our implementation, the policy takes the preference vector, ω, as an additional input along with the state s, to make a decision. The policy loss for the multi-objective PPO

(MO-PPO) is then given by:

$${L}_{θ} = \frac{1}{T} {\sum }_{t = 0}^{T} min ( ρ ( θ ) {ω}^{T} A ( {s}_{t} , {a}_{t} , ω ) , clip ( ρ ( θ ) , 1 - ϵ , 1 + ϵ ) {ω}^{T} A ( {s}_{t} , {a}_{t} , ω ) )$$

$$where$$

$$ρ ( θ ) = \frac{{π}_{θ} ( {a}_{t} \vert {s}_{t} , ω )}{{π}_{{θ}_{old}} ( {a}_{t} \vert {s}_{t} , ω )}$$

To ensure efficient runtime task scheduling, having a neural network with high inference overhead is not desirable. Instead, we use a differentiable decision tree (DDT) as the policy with sigmoid as the activation function at each node. The MO-PPO algorithm can be used for the DDT policy without requiring modifications. For the value network, fully connected layers with hyperbolic tangent activation functions are employed.

Algorithm I (below) outlines the training process of the DTRL framework. At the beginning of each episode during training, we randomly sample a preference vector (ω∈Ω: Σᵢ₋₀^{L} ωᵢ=1) from a uniform distribution. To determine the workload intensity of the task scheduling problem, the simulation framework takes the target throughput (e.g., frames per milliseconds) as input. Thus, at the start of each episode, we randomly sample a target throughput y.

### Algorithm I

Input: Total number of time steps N, Number of steps to run per policy rollout T, Discount factor γ, Number of epochs to update the policy and value network K, Minibatch size b, Number of child processes P, Clipping value ∈.
Initialize: DDT policy π_{θ} and value network V_{ϕ} with parameters θ and ϕ, Random policy π_{θ}.
while Total Number of Steps<N do
//Child Process
Reset the environment to state s₀ and randomly initialize target throughput y.
Sample a preference vector ω from the subspace \tilde{Ω}.
for t=0: T do
   Choose aₜ according the current policy π_{θ} and invalid action mask aₜ^{m}.
   Collect samples {sₜ, aₜ, rₜ, s′ₜ, done} by interacting with the environment using action aₜ.
Obtain Aₜ, rₜ+V_{ϕ}(Sₜ₊₁, ω), and π_{θ}_{_{old}}(aₜ|sₜ, π) using DDT and the value network.
Transfer populated (s, a, r, s′, ω, a^{m}, A, r+V_{ϕ}(s, ω), π_{θ}_{_{old}}(a|s, ω)) to main process.
//Main Process
Store the incoming transitions from child processes in a trajectory buffer with size P×T.
for k=1: K do
   for i=0: (P× T/b) do
      idxₛₜₐᵣₜ=d×(b−1)
      idx_{end}=d×(b)
      Sample a minibatch from the trajectory buffer according to start and end indices.
      Obtain value estimates and new π_{θ}.
      Calculate L_{θ} and L_{ϕ}
      Update θ and ϕ by applying SGD to L_{θ} and L_{ϕ}.

A vectorized architecture with a single policy to gather transitions from multiple environments is described in J. Schulman, F. Wolski, P. Dhariwal, A. Radford, and 0. Klimov. Proximal Policy Optimization Algorithms. arXiv preprint arXiv: 1707.06347, 2017 and used to increase the sample efficiency of this algorithm. We initialize P child processes with different seeds. The DDT policy and the value network are shared among child processes and the main process. We divide the preference space into P sub-spaces (\tilde{Ω}) and assign a subspace to each child process. Each child process is responsible for its own preference sub-space, and in each child process, a preference vector is randomly sampled from its assigned sub-space. Using the policy π_{θ}, we collect T amount of samples. Using these samples, advantages Aₜ, target values rₜ+V_{ϕ}(sₜ₊₁, ω), and the probabilities π_{θ}_{_{old}} (aₜ|sₜ, ω) are obtained. The original PPO implementation uses generalized advantage estimation (GAE) to calculate advantages. We also employ this technique with a GAE parameter of 0.95. These child processes run in parallel to collect transitions and do necessary computations using the same DDT policy and value network. The obtained transitions are then transmitted to the main process, where they are stored in a trajectory buffer of size P×T.

The algorithm then updates both the value network and the DDT policy parameters (ϕ, θ) according to the loss functions described in equations 1 and 3. The total number of optimization steps required to update the parameters is determined by the number of epochs K and the minibatch size b. We use an Adam optimizer with a learning rate of 3E-4 for both the DDT policy and the value network. The hyperparameters for DTRL are presented in Table I.

TABLE I

| Hyperparameter | Description | Value |
|---|---|---|
| P | Number of parallel processes | 10 |
| N_{Layer} | Number of hidden layers in the | 1 |
| | value network | |
| N_{Neuron} | Number of hidden neurons in | 64 |
| | the value network | |
| depth | Depth of DDT policy | 3 |
| N | Total number of time steps for | 3 × 10⁷ |
| | the entire training | |
| T | Number of steps to run per | 1024 |
| | policy rollout | |
| γ | Discount factor | 0.99 |
| λ | GAE Parameter | 0.95 |
| ϵ | Clipping factor | 0.1 |
| K | Number of epochs to update | 20 |
| | the policy and value network | |
| b | Minibatch size | 64 |
| lr | Learning Rate | 3 × 10⁻⁴ |

The heterogeneous computers 10, as noted, typically consist of general-purpose cores and fixed-function accelerators (e.g., fast Fourier transform (FFT), forward error correction (FEC), finite impulse response (FIR). These accelerators do not support all tasks streaming into the DSSoC. Consequently, some tasks involve invalid actions during training. DTRL should be able to manage invalid actions for efficient and stable training. The most common approach to penalize invalid actions is giving a high negative reward such that the agent learns to maximize the reward by not taking any invalid action. However, this approach suffers from low explorative capabilities and spends a vast amount of time learning invalid actions at each state, especially when the action space dimension is large. Therefore, in our work, we use invalid action masking per S. Huang and S. Ontafion. A closer look at invalid action masking in policy gradient algorithms. arXiv preprint arXiv: 2006.14171, 2020 to constrain the DTRL agent to only choose clusters of PEs that support the given task.

In our algorithm, the policy (π_{θ}) generates logits (lᵢ, i=1, . . . , | [symbol] |), which are subsequently converted to action probabilities (π_{θ}(aᵢ|s)) via a softmax operation. During training, an action is selected by sampling from a distribution of these probabilities, denoted as π_{θ}(·|s). The policy is updated using gradient descent, similar to other policy gradient approaches. Invalid action masking is applied by setting the logits of invalid actions to a large negative number, typically −1×10⁸. This ensures that the probability of these masked actions is zero, without compromising the gradient update. In fact, this technique enhances the gradient update, as the gradient corresponding to the logits of masked actions becomes zero.

### Background on PPO

Proximal policy optimization (PPO), described in J. Schulman, F. Wolski, P. Dhariwal, A. Radford, and 0. Klimov. Proximal Policy Optimization Algorithms. arXiv preprint arXiv: 1707.06347, 2017, is a policy gradient algorithm that aims to improve the training stability of the policy by updating it conservatively according to a certain surrogate objective function. Policy gradient algorithms typically update the policy network by computing the gradient of the policy, multiplied by the discounted cumulative rewards, and using it as a loss function with a gradient ascent algorithm. This update is typically performed using samples from multiple episodes since the discounted cumulative rewards can vary widely due to the different trajectories followed by each episode. To mitigate this variance, an advantage function is introduced as a bias to quantify the benefits of the goodness of taking action a in state s and is represented as:

$$A ( {s}_{t} , {a}_{t} ) = {r}_{t} + γ {V}_{ϕ} ( {s}_{t + 1} ) - {V}_{ϕ} ( {s}_{t} )$$

Here, γ∈[0,1] is the discount factor, and V_{ϕ}(s) is the value network that estimates the expected discounted sum of rewards for a given state s.

At each optimization step during training, the PPO algorithm forces the distance between the new policy (π_{θ}(a|s)) and the old policy (π_{θ}_{_{old}}(a|s)) to be small. It achieves its goal using the following loss function and the advantage function:

$${L}_{θ} = \frac{1}{T} {\sum }_{t = 0}^{T} min ( ρ ( θ ) {A}_{t} , clip ( ρ ( θ ) , 1 - ϵ , 1 + ϵ ) {A}_{t} ) \\ ρ ( θ ) = \frac{{π}_{θ} ( {a}_{t} \vert {s}_{t} )}{{π}_{{θ}_{old}} ( {a}_{t} \vert {s}_{t} )}$$

where, T is the total time steps of collected data. The equation presented involves two policies: π_{θ}_{_{old}}(a|s), which is used to collect samples by interacting with the environment, and π_{θ}(a|s), which is being updated using the loss function. PPO introduces a constraint on the difference between π_{θ}_{_{old}}(a|s) and π_{θ}(a|s) by applying a clipping operation on the ratio ρ(θ) between two distributions, with the clipping threshold ∈ being a hyperparameter of the algorithm. Additionally, an entropy term may be added to the loss function to promote sufficient exploration.

During training, the value network V_{ϕ}(s) is also updated by minimizing the mean-squared error between estimated and target values using gradient descent as the optimization algorithm:

$${L}_{ϕ} = \frac{1}{T} {\sum }_{t = 0}^{T} {( {V}_{ϕ} ( {s}_{t} ) - ( {r}_{t} + γ {V}_{ϕ} ( {s}_{t + 1} ) ) )}^{2}$$

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

To aid the Patent Office and any readers of any patent issued on this application in interpreting the claims appended hereto, applicants wish to note that they do not intend any of the appended claims or claim elements to invoke 35 U.S.C. 112 (f) unless the words “means for” or “step for” are explicitly used in the particular claim.

What we claim is:

1. A computer architecture of a computer comprising:
a plurality of heterogeneous processor cores having clusters of homogeneous processor cores; and
a computer memory storing operating program instructions that when executed on the computer cause the computer to:
(1) collect a set of feature values related to performance of the heterogeneous processor cores during up execution of application program instructions comprised of tasks;
(2) identify a task of the application program instructions to be executed on a plurality of heterogeneous processor cores;
(3) apply the feature values to a decision tree providing a set of nodes selecting among branches to other nodes according to a node function and the feature values to identify to a leaf node associated with a cluster; and
(4) assign the task to the cluster identified by the identified leaf node.

2. The computer architecture of claim 1 wherein the operating program when executed on the computer further assigns the task to a processor core of the identified cluster according to an availability of the processor cores.

3. The computer architecture of claim 1 wherein the feature values are selected from the group consisting of: a position of a task in a directed graph of the application, an application type, and an availability of processor cores within the clusters.

4. The computer architecture of claim 1 wherein the operating program when executed on the computer receives an objective value indicating desired trade-off between different scheduling objectives and wherein performance value is applied as a feature value to the decision tree.

5. The computer architecture of claim 4 wherein the objective value indicates a desired balance between energy-power consumption of the computer and execution speed of the application program.

6. The computer architecture of claim 1 wherein the decision tree is differentiable.

7. The computer architecture of claim 1 wherein at least some node functions are differentiable functions of multiple feature values.

8. The computer architecture of claim 7 wherein at least some node functions are a vector multiplication of a weight factor times a vector of feature values.

9. The computer architecture of claim 1 wherein the node functions include multiple weight values trained using a simulation of the computer.

10. The computer architecture of claim 9 wherein the training employs multiple different application programs and multiple objective values selected from the group consisting of: computer energy usage and application program execution time.

11. A method of scheduling tasks on a computer architecture having a plurality of heterogeneous processor cores having clusters of homogeneous processor cores, comprising:
(1) collecting a set of feature values related to performance of the heterogeneous processor cores during up execution of application program instructions comprised of tasks;
(2) identifying a task of the application program instructions to be executed on a plurality of heterogeneous processor cores;
(3) applying the feature values to a decision tree providing a set of nodes selecting among branches to other nodes according to a node function the feature values to identify to a leaf node associated with a cluster; and
(4) assigning the task to the cluster identified by the identified leaf node.

12. The method of claim 11 further including assigning the task to a processor core of the identified cluster according to an availability of the processor cores.

13. The method of claim 11 wherein the feature values are selected from the group consisting of: a position of a task in a directed graph of the application, an application type, and an availability of processor cores within the clusters.

14. The method of claim 11 including receiving an objective value indicating desired trade-off between different scheduling objectives and wherein performance value is applied as a feature value to the decision tree.

15. The method of claim 14 wherein the objective value indicates a desired balance between energy consumption of the computer and execution speed of the application program.

16. The method of claim 11 wherein the decision tree is differentiable.

17. The method of claim 11 wherein at least some node functions are differentiable functions of multiple feature values.

18. The method of claim 17 wherein at least some node functions are a vector multiplication of a weight factor times a vector of feature values.

19. The method of claim 11 wherein the node functions include multiple weight values trained using a simulation of the computer.

20. The method of claim 19 wherein the training employs multiple different application programs and multiple objective values selected from the group consisting of:
computer energy usage and application program execution time.
